(19) United States
(12) Patent Application Publication
(10) Pub. No.: US 2005/0256720 A1
(43) Pub. Date: Nov. 17, 2005

(54) Voice-activated audio/visual locator with voice recognition

(76) Inventor: Laura M. Iorio, Cheshire, CT (US)

Correspondence Address: ABELMAN, FRAYNE & SCHWAB, 666 THIRD AVENUE, 10TH FLOOR, NEW YORK, NY, 10017, US

(21) Appl. No.: 11/128,858

(22) Filed: May 12, 2005

Related U.S. Application Data
(60) Provisional application No. 60/570,944, filed on May 12, 2004.

(51) Int. Cl. G10L 11/00

(52) U.S. Cl. 704/275

(57) ABSTRACT

A self-contained, battery-powered device produces a visible signal and/or an audible sound when activated. The device includes an electronic microphone, a voice recognition program and a controller circuit for activating the audio and/or visual signals in response to the appropriate voice signal of the user. The device is attached to an item to be located. During a search for the item attached to the signaling device, the user sends the appropriate voice signal which is recognized by the signaling device which responds by generating the audio and/or visual signals, allowing the sought-for item to be found by the user.

### CROSS-REFERENCE TO RELATED APPLICATIONS

This application claims priority to U.S. provisional patent application Ser. No. 60/570,944, filed May 12, 2004, now expired, the disclosure of which is incorporated herein by reference in its entirety.

### 1. FIELD OF THE INVENTION

This invention relates to portable electronic devices that are used to locate small household or personal items, such as keys, eyeglass cases, television remote controllers and the like that have been misplaced.

### 2. BACKGROUND OF THE INVENTION

A battery-powered hand-held signal transmitter that is capable of triggering alarms in three or more remote household or personal items that serve to assist the user in locating the misplaced items is known. The transmitter issues an electronic signal. The use of voice recognition technology does not appear to have been utilized in connection with devices used for this purpose.

Also known are devices used to control table lamps and the like that response to the clapping of the hands or other singular or sequential loud noises.

I have invented a self-contained, battery-powered signaling device that produces a visible signal and/or an audible sound when activated to aid in the location of relatively small articles attached to the signaling device that have been misplaced.

### BRIEF SUMMARY OF THE INVENTION

This invention is directed to a self-contained, battery-powered signaling device that produces a visible signal and/or an audible sound when activated. The signaling device includes an electronic microphone, a voice recognition program and a controller circuit for activating the audio and/or visual signals in response to the appropriate voice signal of the user. The signaling device is attached to an item to be located. During a search for the item attached to the signaling device, the user sends the appropriate voice signal corresponding to the item, with the voice signal recognized by the signaling device which responds by generating the audio and/or visual signals, allowing the sought-for item to be found by the user.

The signaling device is used to aid in the location of relatively small articles that have been misplaced in the home or office, such as a key case, cell phone, eyeglass case, or the like. The signaling device is completely self-contained in an appropriate impact-resistant housing that includes fastening means, e.g., hook-and-loop fasteners (VELCRO™) or a permanent or releasable adhesive. The housing has an opening of sufficient size and configuration to allow voice signals or commands to reach the electronic microphone.

One embodiment contemplates that the signaling device can be programmed by the user to recognize the particular command of the user who will program the signaling device for a particular article. The training command could be short, such as “find cell phone” or “locate TV remote”.

In another embodiment, the signaling device is preprogrammed to respond to a particular series of words, letters, or the like. The particular sequence of words would be unusual or unlikely to be used in combination in ordinary conversation. Such coding could be “x-ray zebra” for a first item, and “charlie bravo” for a second item.

Thus, the principal features of the signaling device are:
1. a self-contained signaling device that does not require a base station or other type of transmitter;
2. voice activated; and
3. responsive to one or more unique voice commands.

Accordingly, the present invention includes a signaling device having a microphone for detecting a voice command from a user; a processor for converting the voice command to a digital signal corresponding to the voice command; a control circuit for determining if the digital signal matches a code corresponding to a first item of a plurality of items to be recognized, for generating an activation signal if a match occurs, and for not generating the activation signal if no match is found; and an output device, responsive to the activation signal, for generating a sensory signal to be sensed by the user.

The output device can include a speaker to generate the sensory signal to be audible to the user, or can include a light source to generate the sensory signal to be visible to the user, with the light source optionally being a light emitting diode.

The code can be pre-programmed in the control circuit to correspond to the first item, or the control circuit can be trained by the user to associate the code with the first item. The processor can include voice recognition means for converting the speech of the user in the voice command to the digital signal.

A housing can retain therein the microphone, the processor, the control circuit, and the output device, and the housing can include a wall and an aperture in the wall, with at least a portion of the output device being exposed through the aperture for outputting the sensory signal to the user. The housing can also include a wall and a plurality of perforations in the wall, with the microphone being substantially adjacent to the plurality of perforations for receiving therethrough the voice command from the user.

The housing is attachable to fastening means for attaching the housing to one of the plurality of items, and the fastening means can include hook-and-loop fasteners, or can include adhesive.

An item location kit is also disclosed which can include fastening means; and a signaling device having a housing attachable to the fastening means for connecting the signaling device to one of a plurality of items to be located, with the housing retaining therein a power source; a microphone for detecting a voice command from a user corresponding to a first item to be located; a processor connected to the power source for receiving operating power therefrom, and electrically connected to the microphone for converting the voice command to a digital signal corresponding to the voice command; a control circuit electrically connected to the processor for determining if the digital signal matches a code corresponding to the first item of a plurality of items to be recognized, for generating an activation signal if a match occurs, and for not generating the activation signal if no match is found; and an output device, connected to the control circuit and responsive to the activation signal, for generating a sensory signal to be sensed by the user.

The output device can include a speaker to generate the sensory signal to be audible to the user, or can include a light source to generate the sensory signal to be visible to the user. The processor can include voice recognition means for converting the speech of the user in the voice command to the digital signal, and the housing includes a wall and an aperture in the wall; and with at least a portion of the output device being exposed through the aperture for outputting the sensory signal to the user.

A method for vocally locating a first item is also disclosed, with the method having the steps of receiving a spoken voice command at a microphone of a signaling device connected to the first item by fastening means, with the voice command corresponding to the first item; converting the voice command to a digital signal corresponding to the voice command using a processor electrically connected to the microphone; determining if the digital signal matches a code corresponding to the first item of a plurality of items to be recognized using a control circuit electrically connected to the processor; generating an activation signal if a match occurs; not generating the activation signal if no match is found; and if the activation signal is generated, generating a sensory signal output from an output device to be sensed by the user, with the output device being connected to the control circuit and responsive to the activation signal.

### BRIEF DESCRIPTION OF THE DRAWINGS

Preferred embodiments of the invention are described hereinbelow with reference to the drawings wherein:

FIG. 1 illustrates a schematic diagram of the apparatus of the invention.

### DETAILED DESCRIPTION OF THE INVENTION

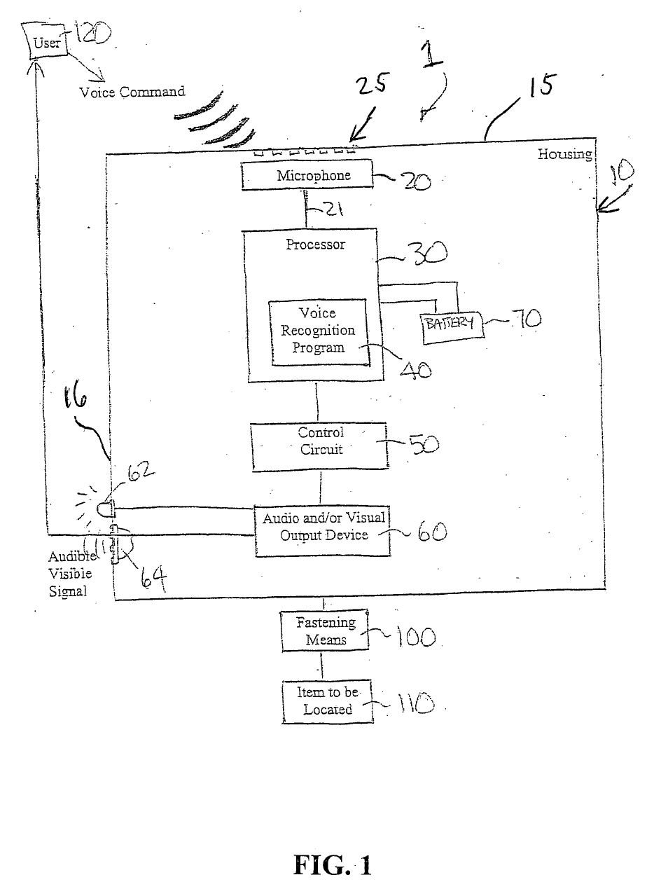

The attached FIG. 1 is a schematic illustration of the signaling device 1 of the invention in the form of a block diagram, which also illustrates its mode of operation.

The signaling device 1 of the present invention is a self-contained, battery-powered device that produces a visible signal and/or an audible sound when activated upon recognition of predetermined voice commands from a user who cannot locate an item 110 to be located to which the signaling device 1 is attached by fastening means 100. Housing 10 of the signaling device 1 can be provided with the fastening means 100, e.g., adhesive or a pair of hook-and-loop fasteners. The fastening means 100 allows the signaling device 1 to be attached initially to an item 110 to be located at some time in the future, e.g., the item 110 can be a key case, cell phone, eyeglass case, a television remote controller, or the like, misplaced and to be located during operation and use of the present invention.

The housing 10 of the signaling device 1 contains a pick-up electronic microphone 20, a processor 30 operating a voice recognition program 40, and a controller circuit 50 for activating the audio and/or visual signals using an audio and/or visual output device 60 in response to the appropriate voice signal of the user 120. In the embodiment that produces an audible signal, the signaling device 1 includes a solid state memory device and/or signal source and a speaker 64, or combination speaker/microphone combining the speaker 64 with the microphone 20.

The pick-up microphone 20 is positioned substantially adjacent to perforations 25 in at least one wall 15 of the housing 10, for receiving a voice command from user 120 in analog form. The microphone 20 converts the received voice command into an electric signal 21, for example, an analog signal corresponding to the voice command, and the signal 21 from the microphone 20 is converted in the processor 30 to a digital signal which is analyzed by the voice recognition program 40. The processor 30 is connected to a power source such as a battery 70, which can be removable and/or rechargeable, for providing operating power to the signaling device 1.

In one example embodiment, the voice recognition program 40 can be implemented as predetermined software stored in an internal memory of the processor 30 and continually executed by the processor 30. In another example embodiment, the processor 30 can be preprogrammed with the voice recognition program 40 hard wired into the circuitry of the processor 30.

If the digital signal corresponding to the voice command and generated by the processor 30 using the voice recognition program 40 is recognized as one of the programmed voice commands encoded as a plurality of codes for which a responsive audible and/or visual signal is to be generated by the signaling device 1, control circuit 50 actuates the audio and/or visual output device 60 to generate an audible and/or a visible signal. A visual signal emanates from, e.g., high intensity light emitting diode (LED) source 62 in an aperture in the wall 16 of the housing, and/or an audible signal emanates from a speaker 64 mounted adjacent to perforations in the wall 16 of the housing 10.

The signaling device 1 is used to aid in the location of relatively small articles 110 to be located that have been misplaced in the home or office, such as a key case, cell phone, eyeglass case, a television remote controller or the like. The signaling device 1 is completely self-contained in an appropriate impact-resistant housing 10 that includes fastening means 100, e.g., hook-and-loop fasteners (VELCRO™) or a permanent or releasable adhesive. The housing 10 has an opening in the perforations 25 of sufficient size and configuration to allow voice signals or commands to reach the electronic microphone 20 for generation and voice recognition of corresponding digital signals.

One embodiment contemplates that the signaling device 1 can be programmed by the user to recognize the particular command of the user who will program the device for a particular article to be located 110. The training command could be short, such as “find cell phone” or “locate TV remote”.

In another embodiment, the signaling device 1 is preprogrammed to respond to a particular series of words, letters, or the like. The particular sequence of words would be unusual or unlikely to be used in combination in ordinary conversation. Such coding could be “x-ray zebra” for a first item, such as house keys, and “charlie bravo” for a cell phone. Accordingly, unrecognized phrases would not cause the signaling device 1 to generate an audible and/or visual signal. Thus, the principal features of the signaling device 1 are:
1. a self-contained signaling device that does not require a base station or other type of transmitter;
2. voice activated; and
3. responsive to one or more unique voice commands.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

1. A signaling device associated with a first item, the signaling device comprising:
a microphone for detecting a voice command from a user;
a processor for converting the voice command to a digital signal corresponding to the voice command;
a control circuit for determining if the digital signal matches a code corresponding to the first item of a plurality of items to be recognized, for generating an activation signal if a match occurs, and for not generating an activation signal if no match is found; and
an output device, responsive to the activation signal, for generating a sensory signal to be sensed by the user to locate the first item.

2. The signaling device of claim 1, wherein the output device includes a speaker to generate the sensory signal to be audible to the user.

3. The signaling device of claim 1, wherein the output device is a light source to generate the sensory signal to be visible to the user.

4. The signaling device of claim 3, wherein the light source is a light emitting diode.

5. The signaling device of claim 1, wherein the code is pre-programmed in the control circuit to correspond to the first item.

6. The signaling device of claim 1, wherein the control circuit is trained by the user to associate the code with the first item.

7. The signaling device of claim 1, wherein the processor includes:
voice recognition means for converting the speech of the user in the voice command to the digital signal.

8. The signaling device of claim 1, further comprising:
a housing for retaining therein the microphone, the processor, the control circuit, and the output device.

9. The signaling device of claim 8, wherein the housing includes a wall and an aperture in the wall; and
wherein at least a portion of the output device is exposed through the aperture for outputting the sensory signal to the user.

10. The signaling device of claim 8, wherein the housing includes a wall and a plurality of perforations in the wall; and
wherein the microphone is substantially adjacent to the plurality of perforations for receiving therethrough the voice command from the user.

11. The signaling device of claim 8, wherein the housing is attachable to fastening means for attaching the housing to the first item.

12. The signaling device of claim 11, wherein the fastening means includes hook-and-loop fasteners.

13. The signaling device of claim 11, wherein the fastening means includes adhesive.

14. An item location kit comprising:
fastening means connected to a first item to be located; and
a signaling device associated with the first item, with the signaling device having a housing attachable to the fastening means for connecting the signaling device to the first item of a plurality of items to be located, with the housing retaining therein:
a power source;
a microphone for detecting a voice command from a user corresponding to the first item to be located;
a processor connected to the power source for receiving operating power therefrom, and electrically connected to the microphone for converting the voice command to a digital signal corresponding to the voice command;
a control circuit electrically connected to the processor for determining if the digital signal matches a code corresponding to the first item of a plurality of items to be recognized, for generating an activation signal if a match occurs, and for not generating the activation signal if no match is found; and
an output device, connected to the control circuit and responsive to the activation signal, for generating a sensory signal to be sensed by the user to locate the first item.

15. The kit of claim 14, wherein the output device includes a speaker to generate the sensory signal to be audible to the user.

16. The kit of claim 14, wherein the output device is a light source to generate the sensory signal to be visible to the user.

17. The kit of claim 14, wherein the processor includes:
voice recognition means for converting the speech of the user in the voice command to the digital signal.

18. The kit of claim 14, wherein the housing includes a wall and an aperture in the wall; and
wherein at least a portion of the output device is exposed through the aperture for outputting the sensory signal to the user.

19. A method for vocally locating a first item, the method comprising the steps of:
receiving a spoken voice command at a microphone of a signaling device connected to the first item by fastening means, with the voice command corresponding to the first item;
converting the voice command to a digital signal corresponding to the voice command using a processor electrically connected to the microphone;
determining if the digital signal matches a code corresponding to the first item of a plurality of items to be recognized using a control circuit electrically connected to the processor;
generating an activation signal if a match occurs;
not generating the activation signal if no match is found; and
if the activation signal is generated, generating a sensory signal output from an output device to be sensed by the user to locate the first item, with the output device being connected to the control circuit and responsive to the activation signal.

20. The method of claim 19, wherein the sensory signal is selected from the group consisting of an audible signal, a visual signal, and an audio-visual signal.
